(19) United States
(12) Patent Application Publication
(10) Pub. No.: US 2008/0050071 A1
(43) Pub. Date: Feb. 28, 2008

(54) Optical receptacle and optical receptacle module therewith

(75) Inventor: Hidenori Kato, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, Kanagawa (JP)

(21) Appl. No.: 11/838,272

(22) Filed: Aug. 14, 2007

(30) Foreign Application Priority Data
Aug. 23, 2006 (JP) 2006-226625

(51) Int. Cl. G02B 6/42

(52) U.S. Cl. 385/55

(57) ABSTRACT

An optical receptacle is provided with a split sleeve, and a fiber stub having a first optical fiber inserted and fixed in a through hole passing through the center of a ferrule. A length of the split sleeve is determined so that a value obtained by dividing a second distance by a first distance can be in a range from 1.2 to 1.6, where the first distance denotes a distance by which the fiber stub is fitted to the split sleeve from a first end face of the split sleeve in a longitudinal direction of the split sleeve, and the second distance denotes a distance by which a plug ferrule is fitted to the split sleeve from a second end face of the split sleeve in a longitudinal direction of the split sleeve.

### BACKGROUND

1. Field of the Invention

The present invention relates to a structure of an optical receptacle for optical fiber communications, and an optical receptacle module in which the optical receptacle and any one of a light emitting element and a light receiving element are combined.

2. Description of the Related Art

In recent years, as the Internet has been proliferating and volumes of communication data have been becoming larger, optical communication networks have been expanding. In particular, high-speed communications using optical fibers have been rapidly penetrating into the market not only as FTTH (Fiber To The Home) for home use, but also as Gigabit Ethernet™ (GbE) and as 10 Gigabit Ethernet™ (10 GbE) for data storage. In these optical fiber communications, optical receptacle modules each having a function of plugging and unplugging an optical connector plug have been employed. For example, a GBIC module using an SC connector, or an SFP (Small Form Factor Pluggable) module using a smaller LC connector is used for a communication volume of not more than 2.5 Gbps (giga bits per second). In addition, XENPAK using an SC connector, or an XFP module using an LC connector is used for a communication volume of 10 Gbps. The SC connector is standardized by JIS C5973 F04 and IEC 61754-4, and has a diameter of a plug ferrule of 2.5 mm, into which an optical fiber is inserted. The LC connector is standardized by IEC 61754-20 and TIA/EIA-604-10-A, and has a diameter of a plug ferrule of 1.25 mm, into which an optical fiber is inserted.

An optical receptacle module is composed of: any one of a semiconductor laser corresponding to a light emitting element which emits light by converting electricity into light, and a light receiving element which generates electricity by converting light into electricity; and an optical receptacle. The optical receptacle performs a function of combining a connector containing an optical fiber with any one of the light emitting element and the light receiving element.

FIG. 1 is a cross-sectional view showing a conventional optical receptacle 4. The optical receptacle 4 is composed of a receptacle holder 10, a split sleeve 8 and a fiber stub 2. The fiber stub 2 is fitted into the split sleeve 8 on one side. A plug ferrule 6 is inserted into and extracted from the split sleeve 8 on the other side opposite to the side into which the fiber stub 2 is fitted. Although the receptacle holder 10 has a shape seemingly covering the split sleeve 8, the fiber stub 2 and the plug ferrule 6, the receptacle holder 10 actually has a split structure.

The split sleeve 8 is made of a material such as zirconia. As FIG. 3 shows, an outer appearance perspective view of the split sleeve 8, the split sleeve 8 is cylindrical-shaped, and has a slit portion 8a.

The fiber stub 2 is formed by inserting and fixing an optical fiber 2a in a through hole passing through the center of a ferrule 2b. The optical fiber 2a is made of quartz or the like as a core material, and the ferrule 2b is made of a material such as zirconia. Additionally, the fiber stub 2 has one end face being an angle polished face 2c, and has the other end face being a PC (physical contact) polished face 2d.

The plug ferrule 6 is formed by inserting and fixing an optical fiber 6a in a through hole passing through the center of a ferrule 6b. The ferrule 6b is made of a material such as zirconia, as in the case with the ferrule 2b of the fiber stub 2. Additionally, the optical fiber 6a is made by quartz or the like as a core material thereof.

The optical receptacle 4 is assembled in the following manner. Firstly, the fiber stub 2 is press-fitted to one of split parts of the receptacle holder 10. At this time, the fiber stub 2 and the receptacle holder 10 are fitted to each other with a press-fitting surface 12 therebetween, and the length of the fitting is L1.

Next, the split sleeve 8 is fitted to the fiber stub 2. The length of the fitting is L2. Furthermore, the part of the receptacle holder 10 to which the fiber stub 2 is fitted is press-fitted to the other split part of the receptacle holder 10, whereby the optical receptacle 4 is completed.

FIG. 4 shows an optical receptacle module 32 to which this optical receptacle 4 and a light emitting element 18 are fixed. A holder 44 is fixed to the light emitting element 18 by resistance welding. Then, the optical receptacle 4 is adjusted and positioned with respect to the optical axis, and is fixed to the holder 44 by YAG (Yittrium-Aluminuim-Garnet) welding or the like. Note that, in some cases, the holder 44 can be composed of two bodies in order for the holder 44 to have a function to adjust the position of the optical receptacle 4 in a direction of the optical axis.

When the plug ferrule 6 is inserted and fitted in the split sleeve 8, the length of the fitting is L3. An overall length of the split sleeve 8 is L4, and, as shown in FIG. 1, the total of L2 and L3 is not more than L4. Note that a ratio of the length L2 to the length L3 is 1:1.

Japanese Patent Application Laid-open Publication No. 2004-258164 discloses an optical receptacle having a configuration in which: a fiber sub is formed by fixing an optical fiber to a through hole in a ferrule fixing; a rear end portion of the fiber stub is fixed to a receptacle holder; a front end portion of the fiber stub is retained by a sleeve housed in a case fixed to the receptacle holder; and a plug ferrule connected to the front end face of the fiber stub is retained by the sleeve. Furthermore, the disclosed optical receptacle is characterized in that an outer peripheral face of the front end portion of the fiber stub is housed by the case with the sleeve interposed therebetween (refer to Japanese Patent Application Laid-open Publication No. 2004-258164).

### SUMMARY

In one embodiment, an optical receptacle according to the present invention is provided with a split sleeve, and a fiber stub in which a first optical fiber is inserted and fixed in a through hole passing through the center of a ferrule. In the split sleeve, when the fiber stub is fitted to the split sleeve by a first distance from a first end face of the split sleeve in a direction of a length of the split sleeve, and a plug ferrule having a second optical fiber inserted and fixed in a through hole passing through the center of the plug ferrule is fitted to the split sleeve by a second distance from a second end face of the split sleeve in the direction of the length of the split sleeve, the length of the split sleeve is determined so that a value obtained by dividing the second distance by the first distance can be in a range from 1.2 to 1.6.

In another embodiment, an optical receptacle according to the present invention is provided with a split sleeve, and a fiber stub in which a first optical fiber is inserted and fixed in a through hole passing through the center of a ferrule. In the split sleeve, the fiber stub is fitted to the split sleeve by a first distance from a first end face of the split sleeve in a direction of a length of the split sleeve, and a length of the split sleeve is determined so that a value obtained by dividing the length of the split sleeve by the first distance can be in a range from 2.3 to 2.9.

According to the present invention, there are provided: an optical receptacle which suppresses misalignment between optical axes of the fiber stub and the plug ferrule, and thereby suppresses loss of light; and an optical receptacle module using the optical receptacle.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a cross-sectional view showing a conventional optical receptacle;

FIG. 2 is a cross-sectional view showing an optical receptacle of the present invention;

FIG. 3 is an outer appearance perspective view of a split sleeve;

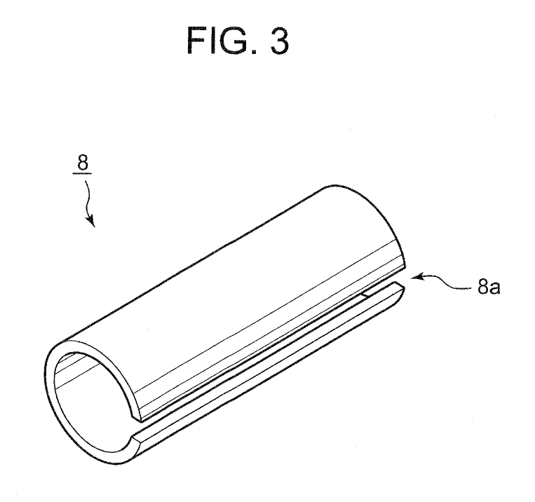

FIG. 4 is a partial cross-sectional view of an optical receptacle module;

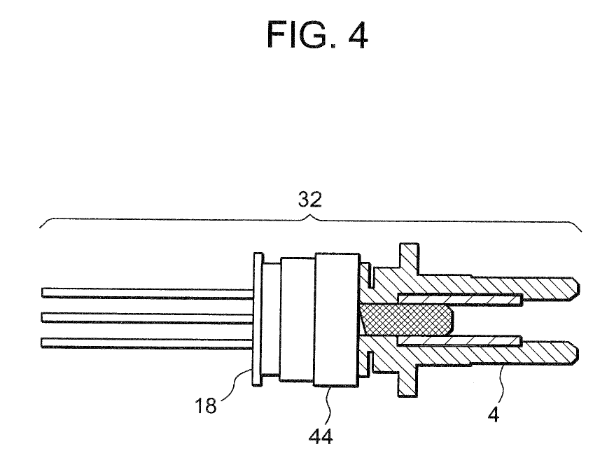

FIG. 5 is a view for explaining an optical wiggle characteristic test;

FIG. 6 is a result of having measured optical wiggle losses when a ratio of a fiber stub fitting length against the split sleeve to a plug ferrule fitting length against the split sleeve was changed in an optical wiggle characteristic test;

FIG. 7 is a result of having measured optical wiggle losses when a value obtained by dividing a length of the split sleeve by the fiber stub fitting length against the split sleeve was changed in an optical wiggle characteristic test; and

FIG. 8 is a result of having measured optical wiggle losses when a ratio of the fiber stub fitting length against the split sleeve to the diameter of the fiber stub was changed in an optical wiggle characteristic test.

### DETAILED DESCRIPTION OF PREFERRED EMBODIMENTS

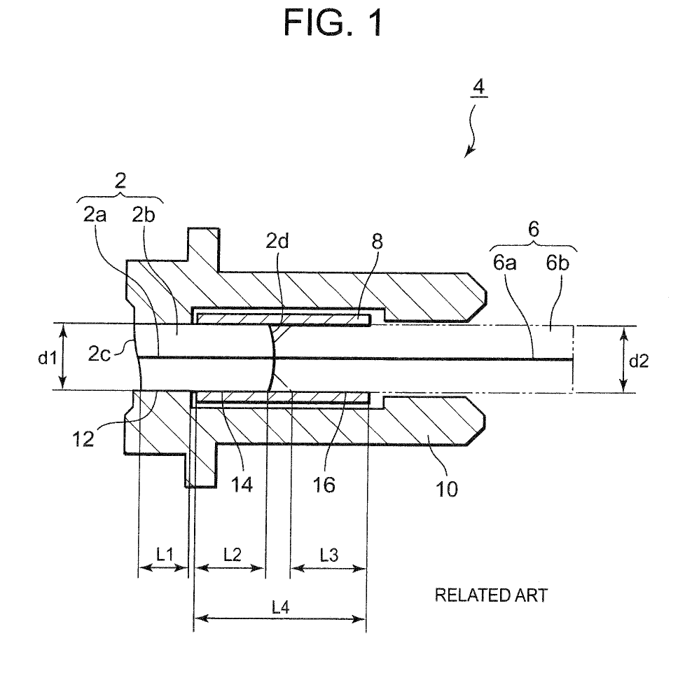

Before describing the invention, the related art will be explained in detail with reference to FIG. 1 in order to facilitate the understanding of the present invention.

As shown in FIG. 1, there is a slight clearance between the split sleeve 8 and the receptacle holder 10, and the split sleeve 8 is fitted to the fiber stub 2 through a fitting surface 14 between the split sleeve and the fiber stub. Since the inner diameter of the split sleeve 8 is slightly smaller than the outer diameter d1 of the fiber stub 2, the fiber stub 2 is fitted to the split sleeve 8 in a state where the inner diameter of the split sleeve 81s expanded. That is, the fiber stub 2 is fitted to the split sleeve 8 by a resilient retaining force of the split sleeve 8.

The optical receptacle 4 has a structure where the fiber stub 2 is press-fitted into the receptacle holder 10 and thereby is fitted to the split sleeve 8. The optical receptacle module 32 is formed by fixing this optical receptacle 4 to, for example, the light emitting element 18. Here, the outer diameter d1 of the fiber stub 2, and the outer diameter d2 of the plug ferrule 6 which is inserted in the optical receptacle module 32 in the field are formed with the same standard.

When the plug ferrule 6 is inserted in the optical receptacle module 32, the plug ferrule 6 is fitted to the split sleeve 8 through a fitting surface 16 between the split sleeve and the plug ferrule. Since the inner diameter of the split sleeve 8 is slightly smaller than the outer diameter d2 of the plug ferrule 6, the plug ferrule 6 is fitted to the split sleeve 8 in a state where the inner diameter of the split sleeve 8 is expanded. That is, the plug ferrule 6 is fitted to the split sleeve 8 by the resilient retaining force of the split sleeve 8.

When the optical receptacle module 32 is in use in the field, an optical-receptacle-side optical connector 22 in which the plug ferrule 6 is embedded is inserted in the optical receptacle 4 and is connected to various apparatuses through an optical cable 28. At that time, a plurality of connectors are bundled into one, and each of the connectors is sometimes put under a load. The load is transmitted to the plug ferrule 6, and acts as a force for moving the plug ferrule 6 in the direction perpendicular to the optical axis thereof. Accordingly, if the force trying to move the plug ferrule 6 in the direction perpendicular to the optical axis is acting, the inner diameter of the split sleeve 8 expands at the time when the force overcomes the resilient retaining force of the split sleeve 8. Then, the force of the split sleeve 8 for retaining the plug ferrule 6 becomes weak, the plug ferrule 6 is inclined with respect to the optical axis of the fiber stub 2, and the optical axes of the plug ferrule 6 and the fiber stub 2 are misaligned with each other as a result.

As has been mentioned above, because there is a clearance between the split sleeve 8 and the receptacle holder 10, the split sleeve 8 can move inside the receptacle holder 10 in the direction of the length of the split sleeve 8. Accordingly, while the plug ferrule 6 is being inserted and fitted in the split sleeve 8, the split sleeve 8 moves toward the fiber stub 2, and there is a point when a ratio of the length (L2) by which the split sleeve 8 is fitted to the fiber stub 2 to the length (L3) by which the split sleeve 8 is fitted to the plug ferrule 6 is 1:0.8. That is, the length (L2) by which the split sleeve 8 is fitted to the fiber stub 2 comes to be longer than the length (L3) by which the split sleeve 8 is fitted to the plug ferrule 6. When the length (L3) by which the split sleeve 8 is fitted to the plug ferrule 6 becomes shorter, a fitting surface 16 between the split sleeve 8 and the plug ferrule 6 becomes smaller, the resilient retaining force of the split sleeve 8 for retaining the plug ferrule 6 becomes smaller. As a result, as has been described above, if the force trying to move the plug ferrule 6 in the direction perpendicular to the optical axis thereof acts, the force overcomes the resilient retaining force of the split sleeve 8, whereby the inner diameter of the split sleeve 8 expands. Then, the force of the split sleeve 8 for retaining the plug ferrule 6 becomes weak, the plug ferrule 6 moves in the direction perpendicular to the optical axis thereof, and the optical axes of the plug ferrule 6 and the fiber stub 2 are misaligned with each other as a result.

Accordingly, in a case where a light emitting element is attached to a side of the fiber stub 2 where the angle polished face 2c is, light going out from the light emitting element is connected to the optical fiber 2a of the fiber stub 2. However, if misalignment between the fiber stub 2 and the plug ferrule 6 has occurred, light connected to the optical fiber 6a of the plug ferrule 6 from the optical fiber 2a of the fiber stub 2 is lost.

That is, when a ratio of the length (L2) by which the split sleeve 8 is fitted to the fiber stub 2 to the length (L3) by which the split sleeve 8 is fitted to the plug ferrule 6 is 1:1, the resilient retaining force of the split sleeve 8 for retaining the plug ferrules 8 is weak. As a result, misalignment between the optical axes of the plug ferrule 6 and the fiber stub 2 occurs, and a problem of losing light arises. It is necessary that length (L3) by which the split sleeve 8 is fitted to the plug ferrule 6 be longer than the length (L2) by which the split sleeve 8 is fitted to the fiber stub 2.

The invention will be now described herein with reference to illustrative embodiments. Those skilled in the art will recognize that many alternative embodiments can be accomplished using the teachings of the present invention and that the invention is not limited to the embodiment illustrated for explanatory purposes.

### First Embodiment

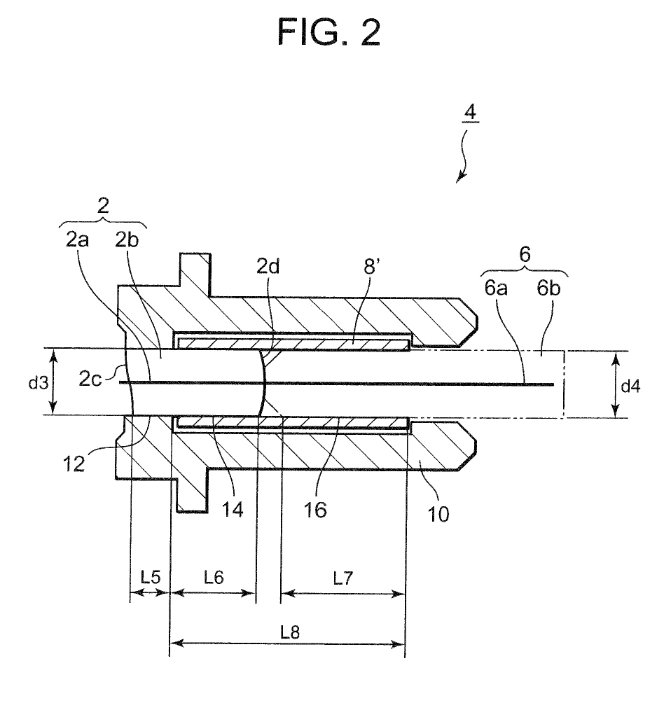

FIG. 2 is a cross-sectional view showing an optical receptacle according to a first embodiment of the present invention. Although a structure of the optical receptacle 4 shown in FIG. 2 does not considerably differ from the conventional optical receptacle, the length of the split sleeve 8′ is different. Additionally, a ratio of the length (L6) by which the split sleeve 8′ is fitted to the fiber stub 2 to the length (L7) by which the split sleeve 8′ is fitted to the plug ferrule 6 is different as compared to the conventional optical receptacle. The length of the split sleeve 8′ is, for example, 5.2 mm. The diameter of the plug ferrule 6 is, for example, 1.25 mm. The fiber stub 2 is press-fitted into the receptacle holder 10, and the fiber stub 2 and the receptacle holder 10 are strongly fitted to each other through the press-fitting surface 12. On the other hand, when the plug ferrule 6 is inserted in the optical receptacle 4, the plug ferrule 6 is only fitted to the split sleeve 8, and is not so strongly fitted as when it is press-fitted. Consequently, in order to prevent misalignment between the optical axes of the optical fiber 2a of the fiber stub 2 and the optical fiber 6a of the plug ferrule 6, the length (L7) by which the split sleeve 8′ is fitted to the plug ferrule 6 is made longer than the length (L6) by which the split sleeve 8′ is fitted to the fiber stub 2. Specifically, the ratio of the length (L6) by which the split sleeve 8′ is fitted to the fiber stub 2 to the length (L7) by which the split sleeve 8′ is fitted to the plug ferrule 6 is prescribed to be in a range from 1:1.2 to 1:1.6. Otherwise, a ratio of a length (L8) of the split sleeve 8′ to the length (L6) by which the split sleeve 8′ is fitted to the fiber stub 2 is prescribed to be in a range from 2.3:1 to 2.9:1. These ranges were obtained by performing tests for evaluating levels of light connection losses occurred due to the misalignment between the optical axes. Contents of the tests will be described later.

Additionally, a value obtained by dividing, by a diameter d3 of the fiber stub 2, the length (L6) by which the split sleeve 8′ is fitted to the fiber stub 2 is prescribed to be not less than 1.3. While the fiber stub 2 is fitted to the split sleeve 8′ through the fitting surface 14 between the split sleeve 8′ and the fiber stub 2, a force of the split sleeve 8′ for retaining the fiber stub 2 is weak if the length (L6) by which the split sleeve 8′ is fitted to the fiber stub 2 is short. If so, even when the length of the split sleeve 8′ is set to a value between the abovementioned prescribed values 2.3:1 to 2.9:1, a balance with the diameter d3 of the fiber stub 2 and a diameter d4 of the plug ferrule 6 is poor, a light connection loss between the fiber stub 2 and the plug ferrule 6 becomes large. Consequently, a test for evaluating levels of light connection losses occurring due to the misalignment between the optical axes was performed, and the abovementioned value 1.3 was obtained. Contents of the test will be described later.

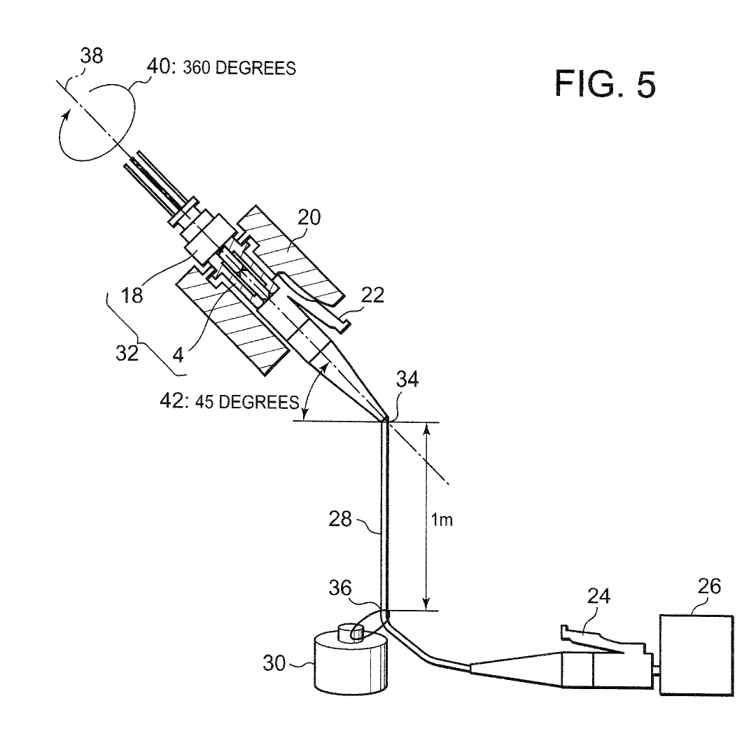

FIG. 5 is a view for explaining an optical wiggle characteristic test for evaluating levels of light connection losses. The optical wiggle characteristic test will be described below. To the optical receptacle 4 corresponding to a specimen, a light emitting element 18 is joined by YAG welding or the like. A combination of the optical receptacle 4 and the light emitting element 18 is the optical receptacle module 32. Note that, in a case where the light emitting element 18 is replaced with a light receiving element, this combination becomes the optical receptacle module 32 used for receiving light. In this optical wiggle characteristic test, the light emitting element 18 is used for the optical receptacle module 32. In addition, the optical receptacle 4 is fixed to a fixing jig 20 used for connection with the optical-receptacle-side optical connector 22. Furthermore, the optical-receptacle-side optical connector 22 including the plug ferrule 6 is fixed to the fixing jig 20 from a side of the fixing jig 20 opposite to a side thereof having the optical receptacle 4. This optical-receptacle-side optical connector 22 is connected to the optical cable 28, and an optical-power-meter-side optical connector 24 is connected to one side of the optical cable 28 in like manner. This optical-power-meter-side optical connector 24 is connected to an optical power meter 26, whereby optical outputs from the optical receptacle module 32 are measured.

A position distant from an end of the optical-receptacle-side optical connector 22 (a weight position starting point 34) by a length of 1 m is set as a weight position 36, and a weight 30 was attached to the optical cable 28. A weight of the weight 30 is set to 350 gf.

The plug ferrule 6 is put under a load of this weight, whereby misalignment between the optical axes of the fiber stub 2 and the plug ferrule 6 occurs. When the misalignment occurs, an optical connection loss of light going out from the light emitting element 18 is caused, and the loss can be measured by the optical power meter 26.

When the optical wiggle characteristic test is performed, the fixing jig 20 is fixed by setting, to 45 degrees, an angle 42 with respect to a horizontal line. Furthermore, with the light emitting element 18 being kept outputting light, the fixing jig 20 is rotated about an optical-axis corresponding axis 38 by giving the fixing jig 20 a rotation angle 40 ranging 360 degrees. First of all, in a state where the fixing jig 20 has not been rotated yet, an optical power is measured by the optical power meter 26, and a thus measured value is set as an initial value. Then, while the rotation angle 40 is given to the fixing jig 20, changes in optical power are measured by the optical power meter 26. A value of the optical power that is lowest among all of values thereof obtained until the fixing jig 20 is rotated by 360 degrees is found, and an optical output difference of that value from the initial value is set as an optical wiggle loss. A unit of the optical wiggle loss is dB. The smaller a value of the optical wiggle loss is, the less susceptible the plug ferrule 6 is to influence from the load of the weight 30. That means an optical connection between the optical-receptacle-side optical connector 22 and the optical receptacle module 32 is more stable against the load.

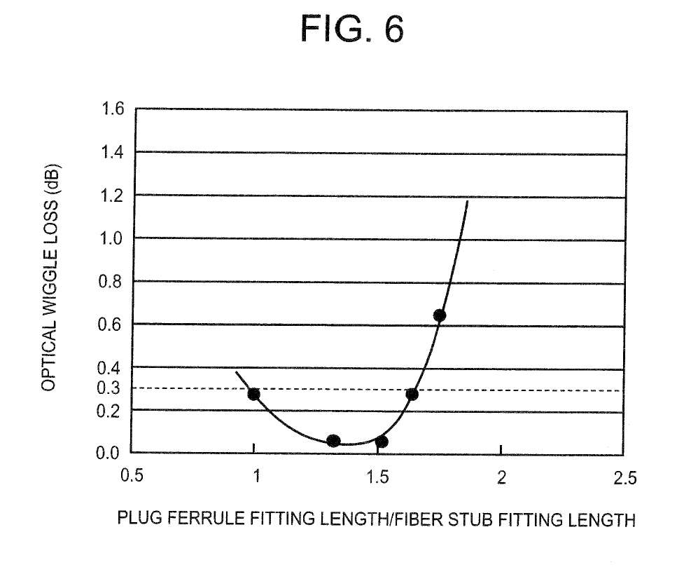

FIG. 6 is a result of having measured optical wiggle losses when the ratio of the fiber stub fitting length (L6) against the split sleeve 8′ to the plug ferrule fitting length (L7) against the split sleeve 8′ was changed in an optical wiggle characteristic test. As has been described above, when the optical wiggle loss is smaller, a more stable characteristic of the optical connection is exhibited against a mechanical load to the optical fiber cable 28. Accordingly, it is desirable that a threshold value of the optical wiggle losses be set to not more than 0.3 dB, and furthermore, that a lower limit of the ratio R of the fiber stub fitting length (L6) against the split sleeve 8′ to the plug ferrule fitting length (L7) against the split sleeve 8′ be set to 1:1.2 by taking a safety factor into consideration. Additionally, if L6 becomes too large, deflection in a part fitted to the plug ferrule 6 becomes large at the time when the plug ferrule 6 is put under a load. Based on the result of this test, it is desirable that an upper limit of R be 1:1.6. While it is required for the optical receptacle module 32 to suppress the optical wiggle loss to not more than about 0.3 dB, the safety factor is taken into consideration because minimizing the optical wiggle loss is desirable so as to satisfy a more stable optical connection characteristic.

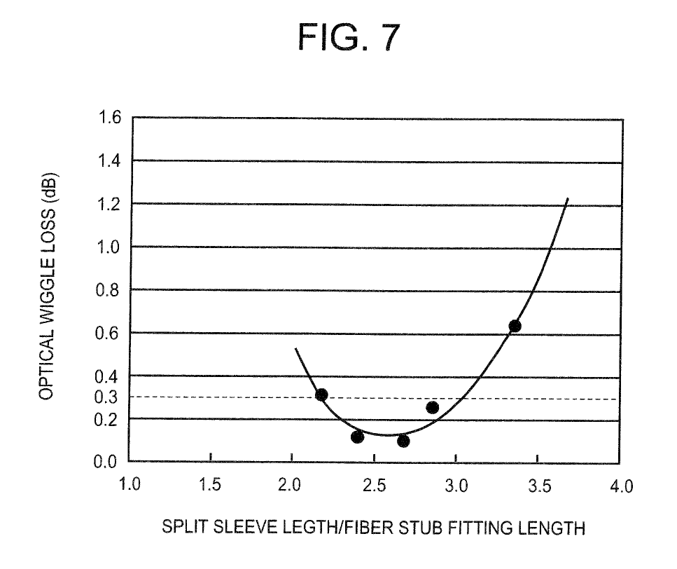

The measurement result in FIG. 6 can be also expressed as optical wiggle losses with respect to various ratios of the length (L8) of the split sleeve 8′ to the fiber stub fitting length (L6) against the split sleeve 8′. FIG. 7 shows a result of having measured optical wiggle losses when the ratio of the length (L8) of the split sleeve 8′ to the fiber stub fitting length (L6) against the split sleeve 8′ was changed in an optical wiggle characteristic test. While it is required that the optical wiggle loss be suppressed to not more than about 0.3 dB, a more stable optical connection characteristic should be satisfied. If a safety factor is taken into consideration because minimizing the optical wiggle loss is preferable, it is desirable that the ratio of the length (L8) of the split sleeve 8′ to the fiber stub fitting length (L6) against the split sleeve 8′ be set in a range from 2.3:1 to 2.9:1.

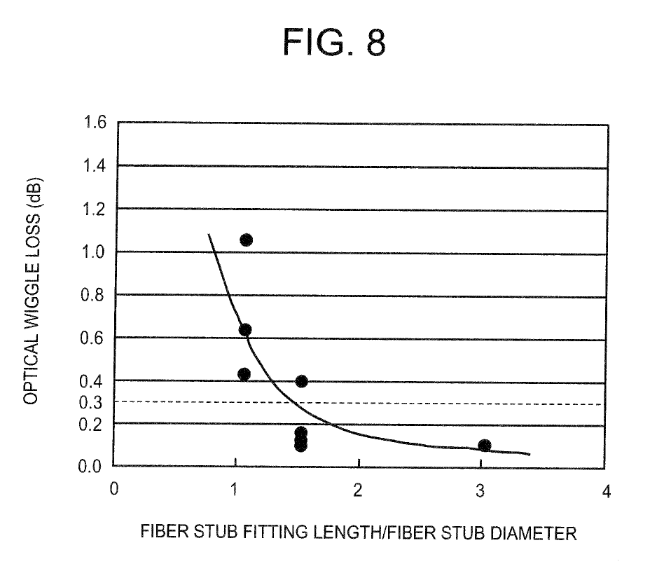

FIG. 8 is a result of having measured optical wiggle losses when the ratio of the fiber stub fitting length (L6) against the length of the split sleeve 8′ to the diameter d3 of the fiber stub 2 was changed in an optical wiggle characteristic test. As the ratio of the fiber stub fitting length (L6) against the split sleeve 8′ to the diameter d3 of the fiber stub 2 becomes larger, the optical wiggle loss becomes smaller. As has been described above, when the optical wiggle loss is smaller, a more stable characteristic of the optical connection is exhibited against a mechanical load to the optical fiber cable 28. Accordingly, it is desirable that the ratio of the fitting length (L6) of the fiber stub 2 against the split sleeve 8′ to the diameter d3 of the fiber stub 2 be set to not less than 1.3 by taking a safety factor into consideration. While it is required for the optical receptacle module 32 to suppress the optical wiggle loss to not more than about 0.3 dB, the safety factor is taken into consideration because minimizing the optical wiggle loss is desirable so as to satisfy a more stable optical connection characteristic.

It is apparent that the present invention is not limited to the above embodiment, but may be modified and changed without departing from the scope and spirit of the invention.

What is claimed is:

1. An optical receptacle comprising:
a split sleeve; and
a fiber stub having a first optical fiber inserted and fixed in a through hole passing through the center of a ferrule,
wherein a length of the split sleeve is determined so that a value obtained by dividing a second distance by a first distance can be in a range from 1.2 to 1.6, where the first distance denotes a distance by which the fiber stub is fitted to the split sleeve from a first end face of the split sleeve in a longitudinal direction of the split sleeve, and the second distance denotes a distance by which a plug ferrule is fitted to the split sleeve from a second end face of the split sleeve in a longitudinal direction of the split sleeve, the plug ferrule having a second optical fiber inserted and fixed in a through hole passing through the center of the plug ferrule.

2. The optical receptacle according to claim 1, wherein the length of the split sleeve is determined so that a value obtained by dividing the first distance by the diameter of the fiber stub can be not less than 1.3.

3. An optical receptacle module comprising:
the optical receptacle according to claim 1; and
a light emitting element which emits light by converting electricity into light,
wherein the optical receptacle and the light emitting element are joined to each other.

4. An optical receptacle module comprising:
the optical receptacle according to claim 2; and
a light emitting element which emits light by converting electricity into light,
wherein the optical receptacle and the light emitting element are joined to each other.

5. An optical receptacle module comprising:
the optical receptacle according to claim 1; and
a light receiving element which generates electricity by converting light into electricity,
wherein the optical receptacle and the light receiving element are joined to each other.

6. An optical receptacle module comprising:
the optical receptacle according to claim 2; and
a light receiving element which generates electricity by converting light into electricity,
wherein the optical receptacle and the light receiving element are joined to each other.

7. An optical receptacle comprising:
a split sleeve; and
a fiber stub having a first optical fiber inserted and fixed in a through hole passing through the center of a ferrule,
wherein a length of the split sleeve is determined so that a value obtained by dividing the length of the split sleeve by a first distance can be in a range from 2.3 to 2.9, where the first distance denotes a distance by which the fiber stub is fitted to the split sleeve from a first end face of the split sleeve in a longitudinal direction of the split sleeve.

8. The optical receptacle according to claim 7, wherein the length of the split sleeve is determined so that a value obtained by dividing the first distance by the diameter of the fiber stub can be not less than 1.3.

9. The optical receptacle according to claim 7, wherein, the diameter of the fiber stub is 1.25 mm and the length of the split sleeve is 5.2 mm.

10. An optical receptacle module comprising:
the optical receptacle according to claim 7; and
a light emitting element which emits light by converting electricity into light,
wherein the optical receptacle and the light emitting element are joined to each other.

11. An optical receptacle module comprising:
the optical receptacle according to claim 8; and
a light emitting element which emits light by converting electricity into light,
wherein the optical receptacle and the light emitting element are joined to each other.

12. An optical receptacle module comprising:
the optical receptacle according to claim 7; and
a light receiving element which generates electricity by converting light into electricity,
wherein the optical receptacle and the light receiving element are joined to each other.

13. An optical receptacle module comprising:
the optical receptacle according to claim 8; and
a light receiving element which generates electricity by converting light into electricity,
wherein the optical receptacle and the light receiving element are joined to each other.
